(19) United States
(12) Patent Application Publication
(10) Pub. No.: US 2017/0362029 A1
(43) Pub. Date: Dec. 21, 2017

(54) Portable Trash Bag Opener

(71) Applicant: James A. Dale, Fort Lauderdale, FL (US)

(72) Inventor: James A. Dale, Fort Lauderdale, FL (US)

(21) Appl. No.: 15/627,438

(22) Filed: Jun. 19, 2017

Related U.S. Application Data
(60) Provisional application No. 62/351,359, filed on Jun. 17, 2016.

(51) Int. Cl. B65F 1/14

(52) U.S. Cl. CPC B65F 1/1415

(57) ABSTRACT

A portable trash bag opener is an apparatus that is used to hold open the rim of a trash bag while a user disposes items into the trash bag. The apparatus includes a hoop, a first arc-shaped wing, a second arc-shaped wing, and a handle. The hoop is used to internally brace the rim of the trash bag. The first arc-shaped wing and the second arc-shaped wing are used to externally clamp the rim of the trash bag against the hoop. The first arc-shaped wing and the second-arc shaped wing are positioned opposite to each other about the hoop. The handle allows the user to easily grasp the apparatus with one of their hands.

The current application claims a priority to the U.S. Provisional Patent application Ser. No. 62/351,359 filed on Jun. 17, 2016. The current application is filed on Jun. 19, 2017 while Jun. 17, 2017 was on a weekend.

### FIELD OF THE INVENTION

The present invention relates generally to an apparatus for use on trash bags. More specifically, the present invention is a has been designed to hold open uncooperative trash bags.

### BACKGROUND OF THE INVENTION

People typically have dealt with unruly trash bags, which flap about as someone is trying to place items inside them. Trash bags commonly go astray because of chaotic winds.

The present invention has been designed to conquer uncooperative trash bags. Instead of having to awkwardly hold open a trash bag with one hand while attempting to load trash with the other, the present invention allows the user to keep the trash bag open and their hands free. The user places the trash bag through the frame of the present invention, which holds the mouth of the trash bag in an open position. The present invention allows users to secure the trash bag to the frame by means of a clamp which snaps directly onto the frame. The clamp ensures that that their bag in not blown away by the wind. The clamp also ensures that the bag does not fall through due to the weight of their trash. With the trash bag held open, users are able to easily and quickly load trash into the bag without worrying about the trash bag coming loose. The frame will be made of a lightweight material that will allow for easy operation and increased durability. The present invention comes with an ergonomic handle for better grip. Additionally, both the frame and the clamp is able to fold in half, which allows for easier storage and transportation.

### BRIEF DESCRIPTION OF THE DRAWINGS

FIG. 1 is a schematic top view of the present invention in the clamping configuration.

FIG. 2 is a schematic top view of the present invention released from the clamping configuration.

FIG. 3A is a schematic top view of the present invention with hinged joints.

FIG. 3B is a schematic top view of the present invention with hinged joints in the collapsed configuration.

FIG. 3C is a schematic bottom view of the present invention with hinged joints in the collapsed configuration.

FIG. 4 is a perspective view of an exemplary embodiment for the present invention released from the clamping configuration.

FIG. 5 is a perspective view of the exemplary embodiment for the present invention in the clamping configuration.

### DETAILED DESCRIPTION OF THE INVENTION

All illustrations of the drawings are for the purpose of describing selected versions of the present invention and are not intended to limit the scope of the present invention.

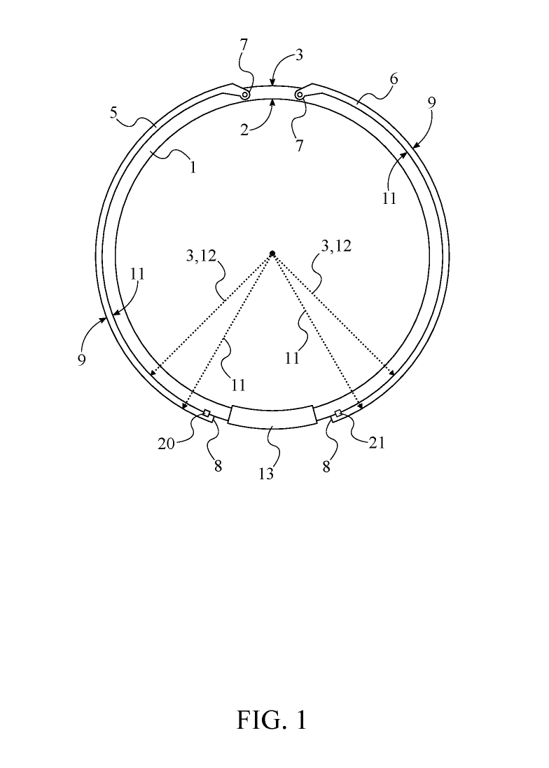

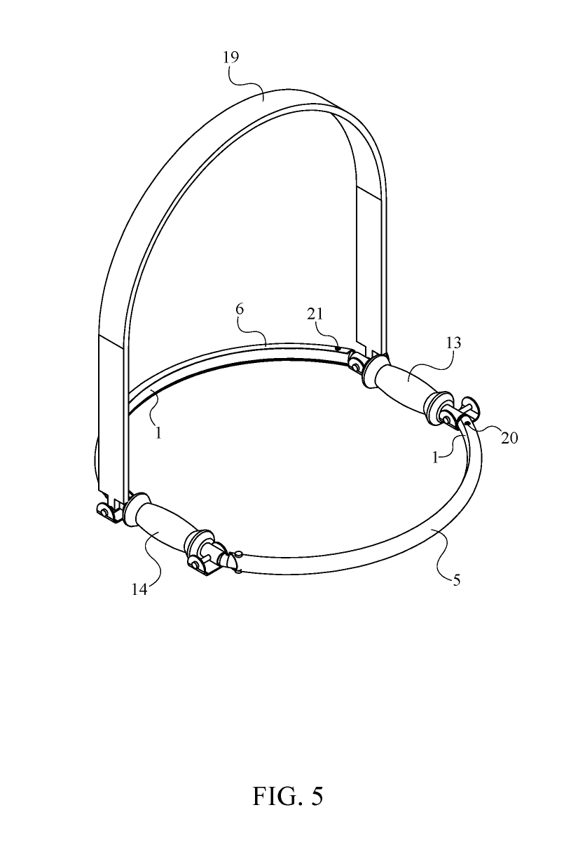

As can be seen in FIGS. 1 and 5, the present invention is a portable trash-bag opener that is used to hold the mouth of a trash bag open while a user disposes items into the trash bag. The mouth of a trash bag has an opening to the trash bag and has a rim of the trash bag that delineates its opening. The present invention comprises a hoop 1, a first arc-shaped wing 5, a second arc-shaped wing 6, and a first handle 13. The hoop 1 is used to shape the rim of trash bag so that the opening of the trash bag is held wider. The hoop 1 comprises an inner portion 2 and an outer portion 3, which are used as references for other components of the present invention. In the preferred embodiment, the hoop 1 has an overall diameter of 16 inches and is made of a half-inch polyvinyl chloride (PVC) tubing. The first arc-shaped wing 5 and the second arc-shaped wing 6 are used as braces to clamp down onto the rim of the trash bag. Also in the preferred embodiment, the first arc-shaped wing 5 and the second arc-shaped wing 6 have a length of 22.5 inches. The first handle 13 allows the user to easily grasp the present invention and thereby hold the trash bag up. Also in the preferred embodiment, the first handle 13 has a length of 5.5 inches. In alternative embodiments, the hoop 1, the first arc-shaped wing 5, and the second arc-shaped wing 6 can be made of aluminum or any other comparable metal or rigid-yet-flexible material.

The general configuration of the aforementioned components allows the present invention to efficiently and effectively hold open the rim of the trash bag. The first arc-shaped wing 5 and the second arc-shaped wing 6 each comprise a fixed end 7, a free end 8, a convex portion 9, and a concave portion 11. The fixed end 7 of the first arc-shaped wing 5 is pivotably connected to the hoop 1, and the fixed end 7 of the second arc-shaped wing 6 is pivotably connected to the hoop 1, which allows the present invention to readily clamp down or release the rim of the trash bag. The pivotably connection between the fixed end 7 and the hoop 1 is preferably configured with a rivet. In addition, the fixed end 7 of the first arc-shaped wing 5 and the fixed end 7 of the second arc-shaped wing 6 are positioned adjacent to each other about the hoop 1 so that the first arc-shaped wing 5 and the second arc-shaped wing 6 can clamp down onto a larger section of the rim of the trash bag. Furthermore, a radius 12 for the concave portion 11 of the first arc-shaped wing 5 is equal to a radius 4 of the outer portion 3 of the hoop 1, and a radius 12 for the concave portion 11 of the second arc-shaped wing 6 is equal to the radius 4 for the outer portion 3 of the hoop 1, which allows the concave portion 11 to seamlessly brace the outer portion 3 as the first arc-shaped wing 5 and the second arc-shaped wing 6 clamp down onto to the rim of the trash bag. In the preferred embodiment, the first arc-shaped wing 5 and the second arc-shaped wing 6 are configured into a minor arc shape in order to prevent the clamping motion of each wing from interfering with each other. The first handle 13 is also integrated into the hoop 1, opposite to the fixed end 7 of the first arc-shaped wing 5 and the fixed end 7 of the second arc-shaped wing 6, so that the user is able to grasp the present invention without interfering with the clamping motion of either the first arc-shaped wing 5 or the second arc-shaped wing 6.

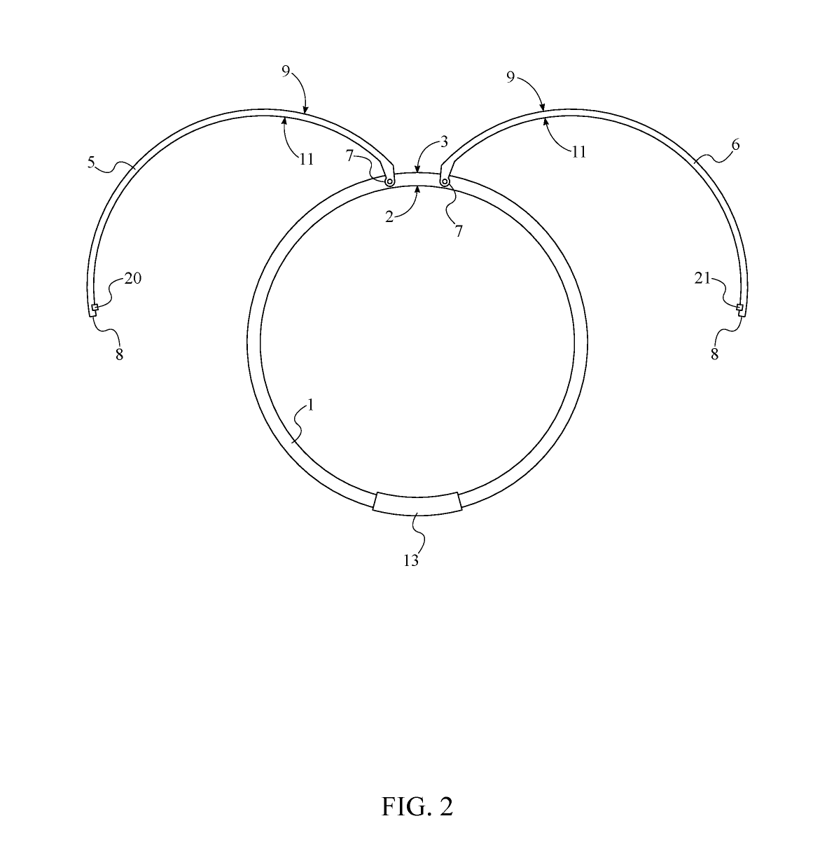

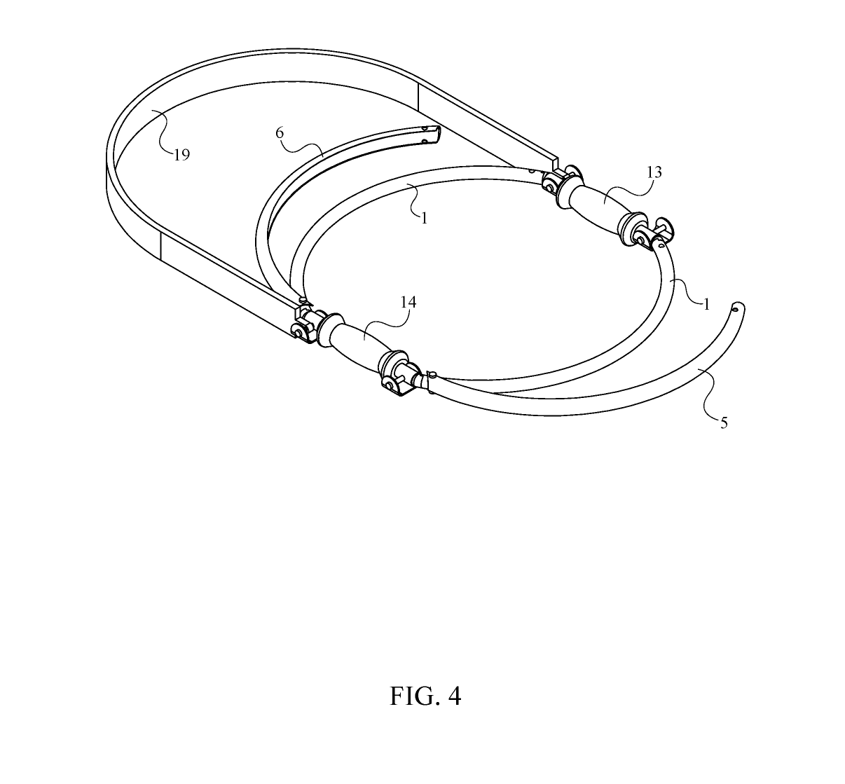

As can be seen FIGS. 2 and 4, the user follows a process in order to properly use the present invention. The user begins by positioning the trash bag within the hoop 1. The user then proceeds to roll or crimp the rim of the trash bag onto the hoop 1. The user continues by placing the hoop 1, the first arc-shaped wing 5, and the second arc-shaped wing 6 into a clamping configuration. For the clamping configuration, the concave portion 11 of the first arc-shaped wing 5 is pressed against the outer portion 3, and the concave portion 11 of the second arc-shaped wing 6 is pressed against the outer portion 3, opposite to the concave portion 11 of the first arc-shaped wing 5, which sandwiches the rim of the trash bag in between the outer portion 3 and the concave portion 11 of either the first arc-shaped wing 5 or the second arc-shaped wing 6. The clamping configuration results in the first arc-shaped wing 5 and the second arc-shaped wing 6 being concentrically positioned with the hoop 1.

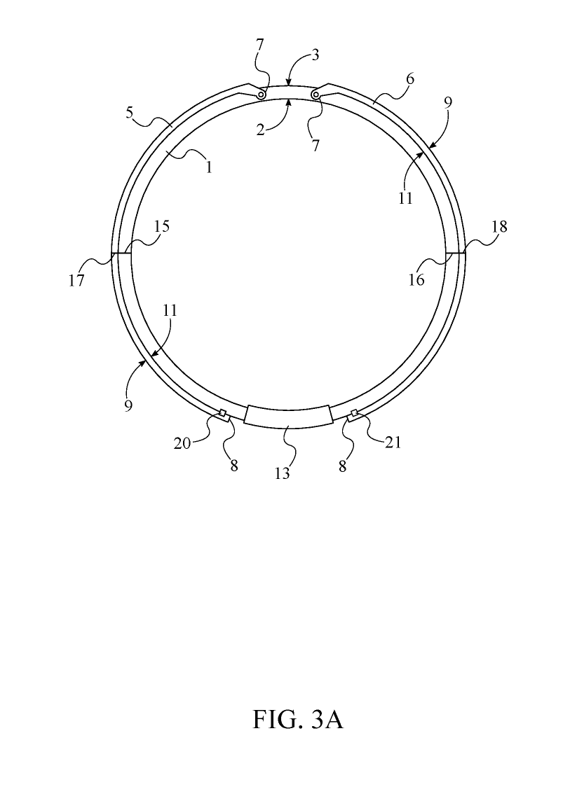

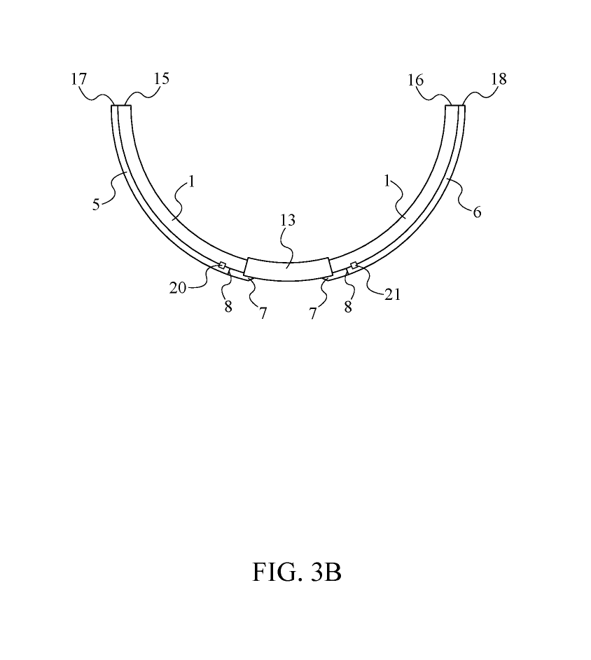

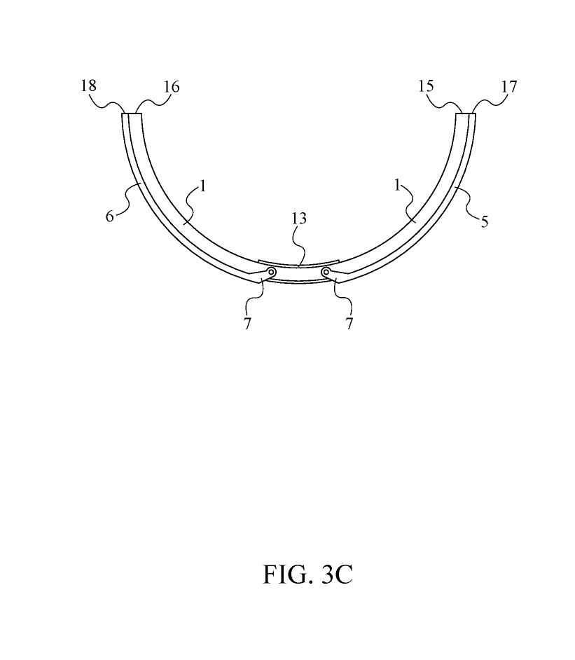

As can be seen in FIG. 3A, the present invention may further comprise a first hinged joint 15, a second hinged joint 16, a third hinged joint 17, and a fourth hinged joint 18, which allows the present invention to be compacted into a space-efficiency form and allows the present invention to be easily stored away. The first hinged joint 15 is integrated into the hoop 1, and the second hinged joint 16 being integrated into the hoop 1. Moreover, the first hinged joint 15 and the second hinged joint 16 are positioned opposite to each other about the hoop 1. This arrangement between the first hinged joint 15, the second hinged joint 16, and the hoop 1 allows the hoop 1 to fold in half, which reduces the overall size of the present invention. In addition, the third hinged joint 17 is integrated into the first arc-shaped wing 5, and the fourth hinged joint 18 is integrated into the second arc-shaped wing 6. This allows both the first arc-shaped wing 5 and the second arc-shaped wing 6 to fold in half and to similarly reduce the overall size of the present invention. Thus, the user can place the hoop 1, the first arc-shaped wing 5, and the second arc-shaped wing 6 into a collapsed configuration. For the collapsed configuration shown in FIG. 3B and 3C, the hoop 1 is folded at the first hinged joint 15 and the second hinged joint 16, while the first arc-shaped wing 5 and the second arc-shaped wing 6 are respectively folded at the third hinged joint 17 and at the fourth hinged joint 18. These folded joints allow the present invention to be significantly reduced in its overall size and allows the present invention to be easily stored away.

As can be seen in FIGS. 4 and 5, the present invention may further comprise a carrying strap 19, which allows the user to hoist the present invention onto one of their shoulders. The carrying strap 19 prevents the user from experiencing the fatigue of endlessly holding up the present invention by the first handle 13 with only one of the user's hands. The carrying strap 19 is connected across the hoop 1 so that the present invention can remain balanced on the user's shoulder. The present invention may also comprise a second handle 14, which allows the user to grasp the present invention with both of their hands. The second handle 14 is integrated into the hoop 1 and is positioned in between the fixed end 7 of the first arc-shaped wing 5 and the fixed end 7 of the second arc-shaped wing 6 about the hoop 1, which similarly allows the user to grasp the present invention without interfering with the clamping motion of either the first arc-shaped wing 5 or the second arc-shaped wing 6. The first handle 13 and the second handle 14 are preferably positioned opposite to each other so that the user is able to grasp the present invention with both of their hands in an ergonomic manner.

Once the rim of the trash bag is clamped in between the outer portion 3 and the concave portion 11 of either the first arc-shaped wing 5 or the second arc-shaped wing 6, the present invention needs to be able to lock the first arc-shaped wing 5 and the second arc-shaped wing 6 in place in order to secure the rim of the trash bag with the present invention. In one embodiment shown in FIG. 5, the present invention further comprises a first locking mechanism 20 and a second locking mechanism 21, which are respectively used to lock the first arc-shaped wing 5 and the second arc-shaped wing 6 in place. The first locking mechanism 20 is integrated into the free end 8 of the first arc-shaped wing 5, and the second locking mechanism 21 is integrated into the free end 8 of the second arc-shaped wing 6 so that the entire length of the first arc-shaped wing 5 and the second arc-shaped wing 6 is held in place in between the free end 8 and the fixed end 7. In another embodiment shown in FIG. 4, a transversal cross-section of the first arc-shaped wing 5 and a transversal cross-section of the second arc-shaped wing 6 are configured into a C-shaped profile, which creates a cavity within the first arc-shaped wing 5 and the second arc-shaped wing 6. This cavity is able to laterally receive and secure the hoop 1.

Although the invention has been explained in relation to its preferred embodiment, it is to be understood that many other possible modifications and variations can be made without departing from the spirit and scope of the invention as hereinafter claimed.

1. A portable trash-bag opener comprises:
a hoop;
a first arc-shaped wing;
a second arc-shaped wing;
a first handle;
the hoop comprises an inner portion and an outer portion;
the first arc-shaped wing and the second arc-shaped wing each comprise a fixed end, a free end, a convex portion, and a concave portion;
the fixed end of the first arc-shaped wing being pivotably connected to the hoop;
the fixed end of the second arc-shaped wing being pivotably connected to the hoop;
the fixed end of the first arc-shaped wing and the fixed end of the second arc-shaped wing being positioned adjacent to each other about the hoop;
a radius for the concave portion of the first arc-shaped wing being equal to a radius of the outer portion of the hoop;
a radius for the concave portion of the second arc-shaped wing being equal to the radius for the outer portion of the hoop; and
the first handle being integrated into the hoop, opposite to the fixed end of the first arc-shaped wing and the fixed end of the second arc-shaped wing

2. The portable trash-bag opener as claimed in claim 1 comprises:
wherein the hoop, the first arc-shaped wing, and the second arc-shaped wing are in a clamping configuration;
the first arc-shaped wing and the second arc-shaped wing being concentrically positioned with the hoop;
the concave portion of the first arc-shaped wing being pressed against the outer portion; and
the concave portion of the second arc-shaped wing being pressed against the outer portion, opposite to the concave portion of the first arc-shaped wing.

3. The portable trash-bag opener as claimed in claim 1 comprises:
a first hinged joint;
a second hinged joint;
a third hinged joint;
a fourth hinged joint;
the first hinged joint being integrated into the hoop;
the second hinged joint being integrated into the hoop;
the first hinged joint and the second hinged joint being positioned opposite to each other about the hoop;
the third hinged joint being integrated into the first arc-shaped wing; and
the fourth hinged joint being integrated into the second arc-shaped wing.

4. The portable trash-bag opener as claimed in claim 3 comprises:
wherein the hoop, the first arc-shaped wing, and the second arc-shaped wing are in a collapsed configuration;
the hoop being folded at the first hinged joint and the second hinged joint;
the first arc-shaped wing being folded at the third hinged joint; and
the second arc-shaped wing being folded at the fourth hinged joint.

5. The portable trash-bag opener as claimed in claim 1 comprises:
a carrying strap; and
the carrying strap being mounted across the hoop.

6. The portable trash-bag opener as claimed in claim 1 comprises:
a first locking mechanism;
a second locking mechanism;
the first locking mechanism being integrated into the free end of the first arc-shaped wing; and
the second locking mechanism being integrated into the free end of the second arc-shaped wing.

7. The portable trash-bag opener as claimed in claim 1 comprises:
a transversal cross-section of the first arc-shaped wing and a transversal cross-section of the second arc-shaped wing being configured into a C-shaped profile, wherein the C-shaped profile is used to laterally receive and secure the hoop.

8. The portable trash-bag opener as claimed in claim 1, wherein the first arc-shaped wing and the second arc-shaped wing are configured into a minor arc shape.

9. The portable trash-bag opener as claimed in claim 1 comprises:
a second handle;
the second handle being integrated into the hoop; and
the second handle being positioned in between the fixed end of the first arc-shaped wing and the fixed end of the second arc-shaped wing about the hoop.

10. The portable trash-bag opener as claimed in claim 9 comprises:
the first handle and the second handle being positioned opposite to each other about the hoop.

11. A portable trash-bag opener comprises:
a hoop;
a first arc-shaped wing;
a second arc-shaped wing;
a first handle;
a first hinged joint;
a second hinged joint;
a third hinged joint;
a fourth hinged joint;
the hoop comprises an inner portion and an outer portion;
the first arc-shaped wing and the second arc-shaped wing each comprise a fixed end, a free end, a convex portion, and a concave portion;
the fixed end of the first arc-shaped wing being pivotably connected to the hoop;
the fixed end of the second arc-shaped wing being pivotably connected to the hoop;
the fixed end of the first arc-shaped wing and the fixed end of the second arc-shaped wing being positioned adjacent to each other about the hoop;
a radius for the concave portion of the first arc-shaped wing being equal to a radius of the outer portion of the hoop;
a radius for the concave portion of the second arc-shaped wing being equal to the radius for the outer portion of the hoop;
the first handle being integrated into the hoop, opposite to the fixed end of the first arc-shaped wing and the fixed end of the second arc-shaped wing.
the first hinged joint being integrated into the hoop;
the second hinged joint being integrated into the hoop;
the first hinged joint and the second hinged joint being positioned opposite to each other about the hoop;
the third hinged joint being integrated into the first arc-shaped wing; and
the fourth hinged joint being integrated into the second arc-shaped wing.

12. The portable trash-bag opener as claimed in claim 11 comprises:
wherein the hoop, the first arc-shaped wing, and the second arc-shaped wing are in a clamping configuration;
the first arc-shaped wing and the second arc-shaped wing being concentrically positioned with the hoop;
the concave portion of the first arc-shaped wing being pressed against the outer portion; and
the concave portion of the second arc-shaped wing being pressed against the outer portion, opposite to the concave portion of the first arc-shaped wing.

13. The portable trash-bag opener as claimed in claim 12 comprises:
wherein the hoop, the first arc-shaped wing, and the second arc-shaped wing are in a collapsed configuration;
the hoop being folded at the first hinged joint and the second hinged joint;
the first arc-shaped wing being folded at the third hinged joint; and
the second arc-shaped wing being folded at the fourth hinged joint.

14. The portable trash-bag opener as claimed in claim 11 comprises:
a carrying strap; and
the carrying strap being mounted across the hoop.

15. The portable trash-bag opener as claimed in claim 11 comprises:
a first locking mechanism;
a second locking mechanism;
the first locking mechanism being integrated into the free end of the first arc-shaped wing; and
the second locking mechanism being integrated into the free end of the second arc-shaped wing.

16. The portable trash-bag opener as claimed in claim 11 comprises:
a transversal cross-section of the first arc-shaped wing and a transversal cross-section of the second arc-shaped wing being configured into a C-shaped profile, wherein the C-shaped profile is used to laterally receive and secure the hoop.

17. The portable trash-bag opener as claimed in claim 11, wherein the first arc-shaped wing and the second arc-shaped wing are configured into a minor arc shape.

18. The portable trash-bag opener as claimed in claim 11 comprises:
a second handle;
the second handle being integrated into the hoop; and
the second handle being positioned in between the fixed end of the first arc-shaped wing and the fixed end of the second arc-shaped wing about the hoop.

19. The portable trash-bag opener as claimed in claim 18 comprises:
the first handle and the second handle being positioned opposite to each other about the hoop.
